(19) United States
(12) Patent Application Publication
(10) Pub. No.: US 2024/0246177 A1
(43) Pub. Date: Jul. 25, 2024

(54) Electrode Manufacturing Device Used For Laser Notching Of Electrode

(71) Applicant: LG Energy Solution, Ltd., Seoul (KR)

(72) Inventors: Sungdong Kim, Daejeon (KR); Sangkee Seo, Daejeon (KR)

(73) Assignee: LG Energy Solution, Ltd., Seoul (KR)

(21) Appl. No.: 18/578,128

(22) PCT Filed: Dec. 5, 2022
(86) PCT No.: PCT/KR2022/019590

§ 371 Date: Jan. 10, 2024

(30) Foreign Application Priority Data
Dec. 16, 2021 (KR) 10-2021-0172820

(51) Int. Cl. B23K 26/362; B23K 37/04; B23K 101/36; H01M 4/04

(52) U.S. Cl. CPC B23K 26/362; B23K 37/0426; H01M 4/04; B23K 2101/36

(57) ABSTRACT

An electrode manufacturing device includes a transfer part, a laser irradiation part, and a pattern jig. The transfer part continuously transfers an electrode sheet in order to perform an electrode notching process. The laser irradiation part irradiates the electrode sheet with a laser beam to perform the electrode notching process. The pattern jig is positioned at a portion facing the laser irradiation part with the electrode sheet interposed therebetween to support the electrode sheet. The pattern jig includes a panel having a pattern hole through which the laser beam that has notched the electrode sheet passes, and the pattern hole has a structure which becomes wider from the front toward the rear along a laser beam traveling direction.

### CROSS-REFERENCE TO RELATED APPLICATIONS

This application is a national phase entry under 35 U.S.C. § 371 of International Application No. PCT/KR2022/019590 filed on Dec. 5, 2022, which claims the benefit of priority based on Korean Patent Application No. 10-2021-0172820 filed on Dec. 6, 2021, all contents of which are incorporated by reference as a part of the present specification.

### TECHNICAL FIELD

The present specification relates to an electrode manufacturing device used for laser notching of an electrode.

### BACKGROUND ART

As the demand for mobile devices, electric vehicles, and the like increases, the demand for secondary batteries is rapidly increasing. In particular, lithium secondary batteries having high energy density and voltage among the secondary batteries have been commercialized and widely used.

The lithium secondary batteries are also classified according to a structure of an electrode assembly having a structure in which a cathode, an anode, and a separator interposed between the cathode and the anode are stacked. Examples of the electrode assembly according to such classification may include a jelly-roll type (wound type) electrode assembly having a structure in which cathodes and anodes having a long sheet shape are rolled with separators interposed therebetween, a stack type (layered type) electrode assembly in which a plurality of cathodes and anodes cut in units of a predetermined size are sequentially stacked with separators interposed therebetween, and the like. Recently, in order to solve problems of the jelly-roll type electrode assembly and the stack type electrode assembly, a stack/folding type electrode assembly, having a form in which the jelly-roll type electrode assembly and the stack type electrode assembly are mixed and having a structure in which unit cells in which cathodes and anodes of a predetermined unit are stacked with separators interposed therebetween are sequentially rolled in a state in which they are positioned on separation films, is also used.

Generally, such a secondary battery is completed by applying and drying electrode mixtures in which an electrode active material, a conductive agent, a binder, and the like are mixed on an electrode current collector to manufacture electrodes, stacking the manufactured electrodes together with a separator, and then embedding and sealing a laminate together with an electrolyte solution in a battery case.

In this case, the electrode is manufactured by notching an electrode sheet manufactured by applying the electrode active material on the electrode current collector having a long sheet shape, and then cutting the electrode sheet at a predetermined length.

Generally, a notching process is performed using a jig or a roller including a cutting part having a shape corresponding to the electrode. Recently, the notching process is also performed by a method of irradiating the electrode sheet with a predetermined laser so that the electrode can be formed in a more precise dimension.

An electrode manufacturing device according to the related art using a laser is illustrated in FIG. 1. As illustrated in FIG. 1, in the electrode manufacturing device according to the related art has a disadvantage of causing a problem that foreign substances (spatters, etc.) generated at the time of notching damage to an electrode sheet while being accumulated or stuck and piled up around a pattern hole 42 of a pattern jig 40.

Therefore, improvement on such a problem is required.

DISCLOSURE

### Technical Problem

The present invention has been devised to solve the problem of the related art as described above, and an object of the present specification is to provide an electrode manufacturing device capable of effectively preventing foreign substances (spatters, etc.) generated at the time of laser notching of an electrode from being accumulated and stuck around a pattern hole of a pattern jig to damage an electrode sheet.

### Technical Solution

In order to achieve the above object, the present specification provides an electrode manufacturing device, including:
a transfer part continuously transferring an electrode sheet in order to perform an electrode notching process;
a laser irradiation part irradiating the electrode sheet with a laser beam to perform the electrode notching process; and
a pattern jig positioned at a portion facing a laser irradiation part with the electrode sheet interposed therebetween to support the electrode sheet,
wherein the pattern jig includes a panel including a pattern hole through which the laser beam that has notched the electrode sheet passes, and the pattern hole has a structure in which it becomes wide from the front toward the rear based on a laser beam traveling direction.

In an embodiment of the present invention, the pattern hole may be formed as a through hole for the panel, and a wall forming the through hole may include an inclined part forming an interior angle of 15° to 80° with an upper surface of the panel in a direction toward the laser irradiation part. Preferably, a wall forming the through hole may include an inclined part an interior angle of 15° to 70° with an upper surface of the panel in a direction toward the laser irradiation part.

In an embodiment of the present invention, the panel may have a thickness of 1.0 mm or less.

In an embodiment of the present invention, the panel including the pattern hole may be a flat panel or a curved panel convex in a direction toward the electrode sheet.

In an embodiment of the present invention, the pattern jig may be fixed to an upper portion of a suction device.

In an embodiment of the present invention, the panel including the pattern hole may be the curved panel convex in the direction toward the electrode sheet, and the pattern jig including the curved panel may be fixed to a cylindrical drum suction.

In an embodiment of the present invention, three to ten pattern jigs including the convex curved panel may be fixed to the cylindrical drum suction, and electrode notching may be performed while the pattern jig is replaced with another pattern jig by rotation of the cylindrical drum suction at the time of electrode notching.

In an embodiment of the present invention, a foreign substance adhesion prevention coating layer may be further provided on a surface of the panel including the pattern hole.

The foreign substance adhesion prevention coating layer may have a friction coefficient of 0.3 or less and a surface roughness of 0.15 μm or less.

In an embodiment of the present invention, the foreign substance adhesion prevention coating layer may be formed of one or more coatings selected from a diamond-like carbon (DLC) coating, an AlCrN (Alcrona) coating.

In an embodiment of the present invention, the electrode sheet may include a coated portion that is coated with an electrode active material and a non-coated portion that is not coated with the electrode active material, on one surface or both surfaces of an electrode current collector.

In an embodiment of the present invention, the electrode manufacturing device may be used in a notching process for forming an electrode tab.

### Advantageous Effects

An electrode manufacturing device according to the present specification includes a pattern jig having an improved structure, and thus, may effectively prevent foreign substances (spatters, etc.) generated at the time of laser notching of an electrode from being accumulated and stuck around a pattern hole of the pattern jig to damage an electrode sheet.

### DESCRIPTION OF DRAWINGS

FIG. 1 is a schematic cross-sectional view illustrating an electrode manufacturing device according to the related art and a use state thereof.

FIG. 2 is a plan view illustrating an embodiment of a pattern jig used in an electrode manufacturing device according to the present invention.

FIG. 3 is a cross-sectional view of illustrating an A-A cross section (a) and a B-B cross section (b) of the pattern jig of FIG. 2.

FIG. 4 is a schematic cross-sectional view illustrating an embodiment of the electrode manufacturing device according to the present invention.

FIG. 5 is a perspective view illustrating another embodiment of the pattern jig used in the electrode manufacturing device according to the present invention.

FIG. 6 is a cross-sectional view of illustrating an A-A cross section of the pattern jig of FIG. 5.

FIG. 7 is a schematic cross-sectional view illustrating another embodiment of the electrode manufacturing device according to the present invention.

FIG. 8 is a photograph illustrating another embodiment of the pattern jig used in the electrode manufacturing device according to the present invention.

FIG. 9 is a schematic cross-sectional view illustrating another embodiment of the electrode manufacturing device according to the present invention.

FIG. 10 is a schematic perspective view illustrating another embodiment of the electrode manufacturing device according to the present invention.

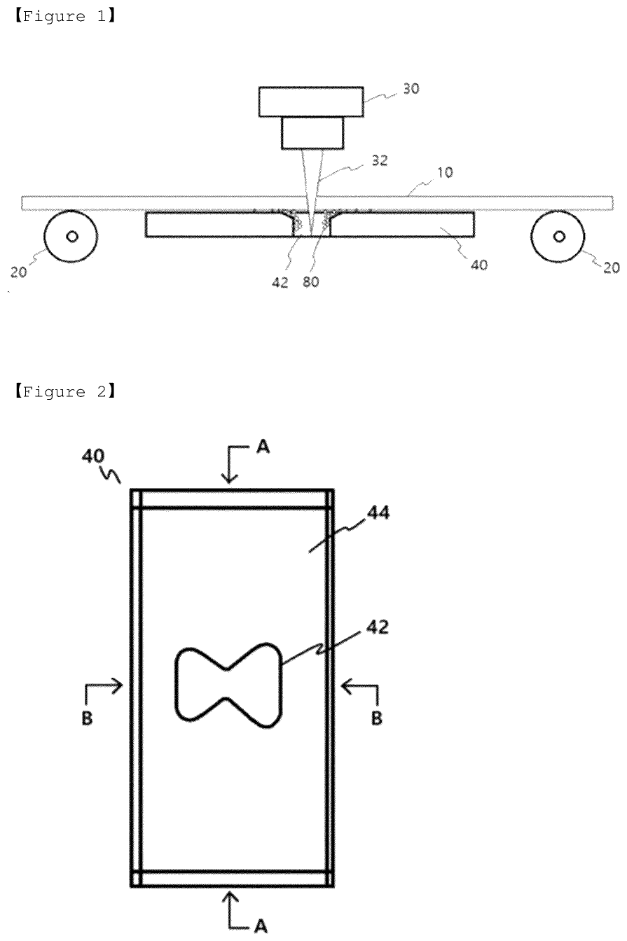

### BEST MODE

Hereinafter, embodiments of the present invention will be described in detail with reference to the accompanying drawings so that those skilled in the art to which the present specification pertains may easily practice the embodiments of the present invention. However, the present invention may be implemented in various different forms, and is not limited to embodiments described herein. Throughout the specification, similar parts will be denoted by the same reference numerals.

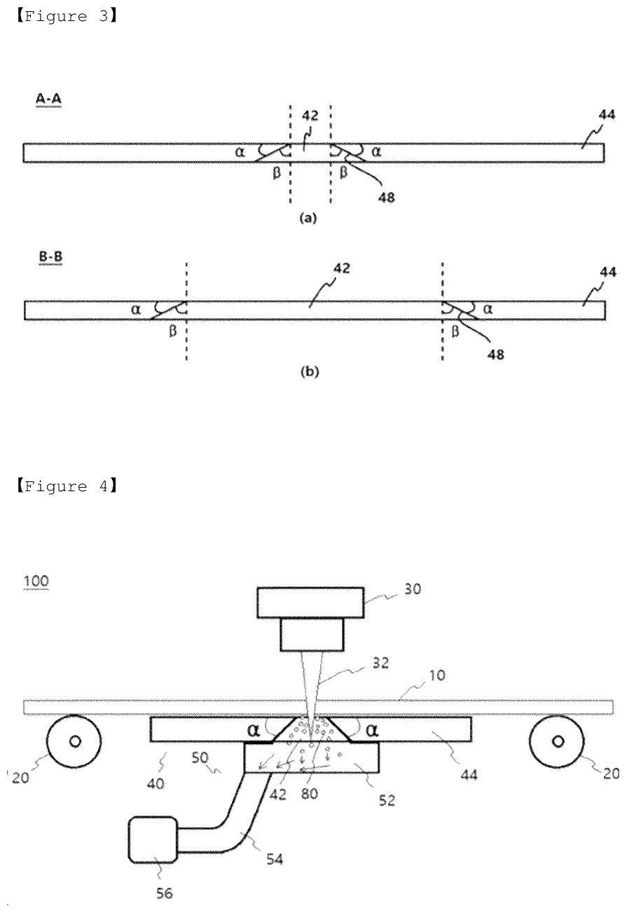

FIG. 2 is a plan view illustrating an embodiment of a pattern jig used in an electrode manufacturing device according to the present invention, FIG. 3 is a cross-sectional view of illustrating an A-A cross section (a) and a B-B cross section (b) of the pattern jig of FIG. 2, and FIG. 4 is a schematic cross-sectional view illustrating an embodiment of the electrode manufacturing device according to the present invention.

The electrode manufacturing device 100 according to the present specification includes a transfer part 20 continuously transferring an electrode sheet 10 in order to perform an electrode notching process; a laser irradiation part 30 irradiating the electrode sheet 10 with a laser beam to perform the electrode notching process; and a pattern jig 40 positioned at a portion facing a laser irradiation part with the electrode sheet 10 interposed therebetween to support the electrode sheet, as illustrated in FIG. 4,
wherein the pattern jig 40 includes a panel 44 including a pattern hole 42 through which the laser beam that has notched the electrode sheet 10 passes, and the pattern hole 42 has a structure in which it becomes wide from the front toward the rear based on a laser beam traveling direction.

The pattern jig 40 may be the panel 44 itself including the pattern hole 42, as illustrated in FIGS. 2 and 3, and may further include a fixing part for fixing the panel 44 to a suction device or the like in addition to the panel 44. The fixing part may include a support member, a fixing means, and the like, for suitably fixing the panel 44 to the suction device or the like. The fixing means may be, for example, a coupling hole for screw coupling, or the like.

In an embodiment of the present invention, the pattern hole 42 is formed as a through hole for the panel, and a wall 48 forming the through hole may include an inclined part forming an interior angle of 15° to 80°, preferably 15° to 70°, and more preferably 15° to 45° with an upper surface of the panel in a direction toward the laser irradiation part, as illustrated in FIG. 3.

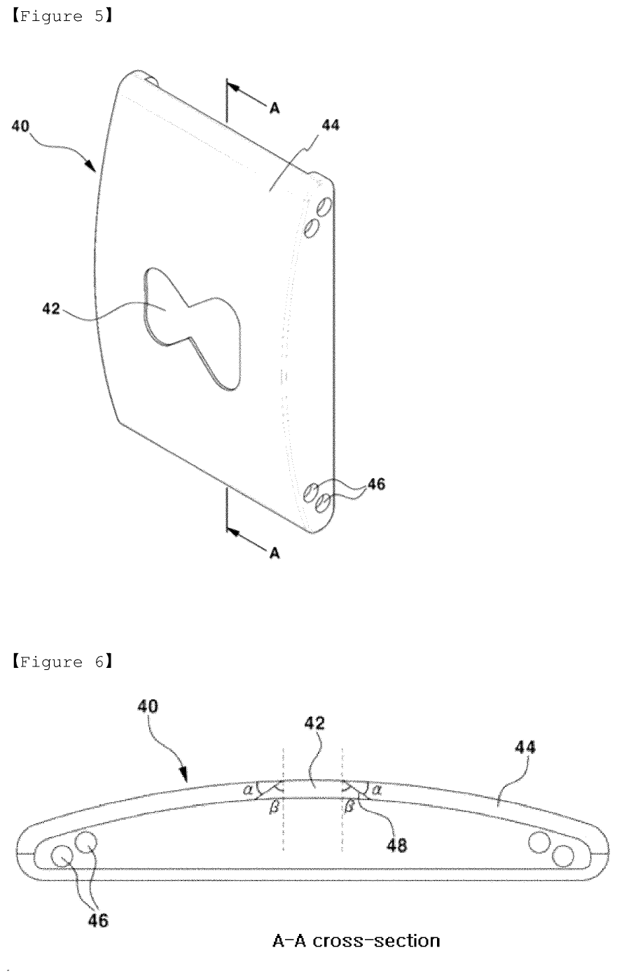

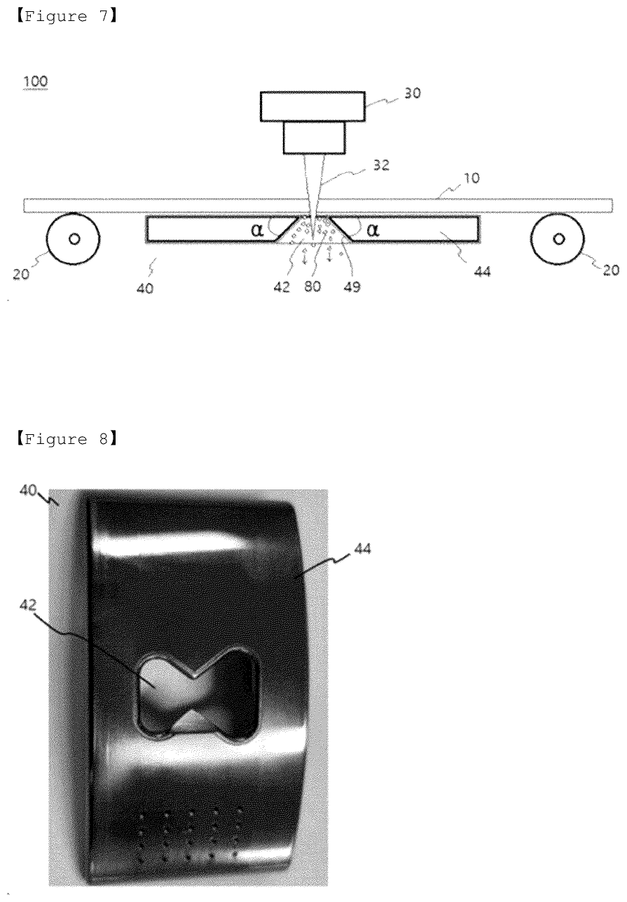

Meanwhile, the wall 48 may include an inclined part forming an interior angle of 10° to 75°, preferably 20° to 75°, and more preferably 45° to 75° based on an axis parallel to a central axis of the laser beam, as illustrated in FIG. 6.

In an embodiment of the present invention, the panel may have a thickness of 1.0 mm or less, preferably 0.7 mm or less, and more preferably 0.5 mm or less.

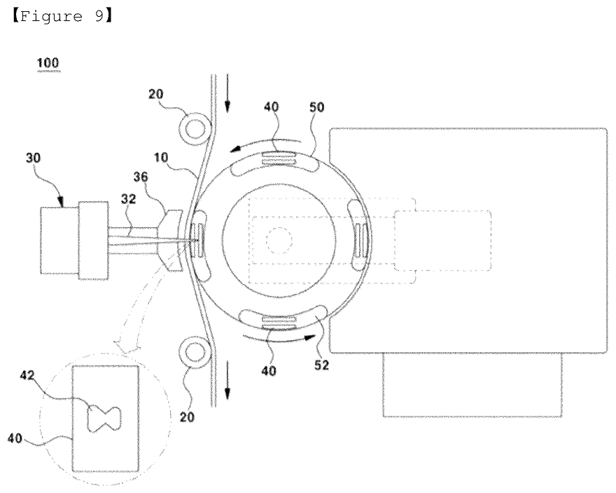

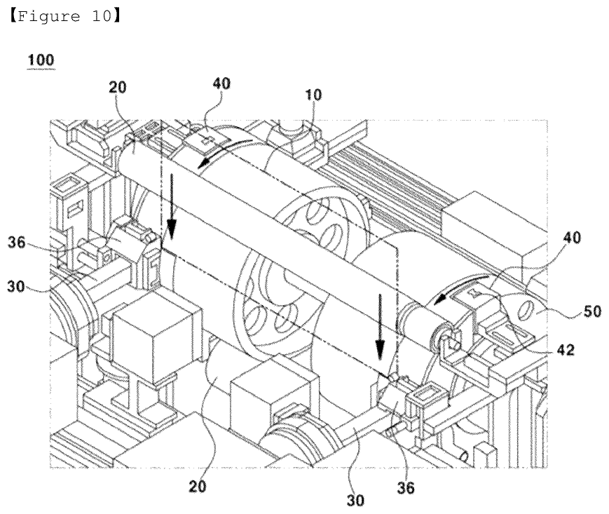

In an embodiment of the present invention, the pattern jig 40 may be fixed to an upper portion of the suction device 50, as illustrated in FIGS. 4 and 9. That is, in the electrode manufacturing device 100 according to the present specification, foreign substances (e.g., spatters) are generated at the time of notching of the electrode sheet 10 by the laser beam, and it is required to suck and remove such foreign substances. Accordingly, the pattern jig 40 may be installed together with the suction device. The suction device is installed in communication with the pattern hole 42 formed in the pattern jig 40, and performs a function of adsorbing foreign substances (e.g., spatters) generated in the pattern hole 42 and around the pattern hole by sucking air. In the above, the term “upper portion” refers to a position determined based on the laser beam traveling direction.

In an embodiment of the present invention, the panel 44 including the pattern hole 42 may be a flat panel as illustrated in FIGS. 2 and 3 or a curved panel 44 convex in a direction toward the electrode sheet as illustrated in FIGS. 5 and 6. FIG. 5 is a perspective view illustrating another embodiment of the pattern jig used in the electrode manufacturing device according to the present invention, and FIG. 6 is a cross-sectional view of illustrating an A-A cross section of the pattern jig of FIG. 5.

When the pattern jig 40 includes the curved panel 44 convex in the direction toward the electrode sheet, the pattern jig 40 may be applied to, for example, an electrode manufacturing device as illustrated in FIG. 9. That is, the pattern jig 40 as described above may be used in a form in which it is fixed to, for example, a cylindrical drum suction 50 as illustrated in FIG. 9.

In the electrode manufacturing device illustrated in FIG. 9, the transfer part 20 of the electrode sheet 10 supplies the electrode sheet 10 so that the electrode sheet 10 can pass over the cylindrical drum suction 50 while surrounding a portion of the cylindrical drum suction 50. In this case, the pattern jig 40 is fixed to a surface of the cylindrical drum suction 50 in contact with the electrode sheet 10, and electrode notching is performed by a laser beam 32 irradiated from laser irradiation part 30.

Three to ten pattern jigs 40 including the curved panel may be fixed to the cylindrical drum suction, and the electrode notching may be performed while the pattern jig 40 is replaced with another pattern jig 40 by rotation of the cylindrical drum suction 50 at the time of electrode notching.

In an embodiment of the present invention, a foreign substance adhesion prevention coating layer may be further provided on a surface of the panel including the pattern hole.

The foreign substance adhesion prevention coating layer may have a friction coefficient of 0.3 or less and preferably 0.15 or less and a surface roughness of 0.15 μm or less and preferably 0.1 μm or less.

When the friction coefficient exceeds 0.3, foreign substances may be accumulated or stuck, which is not preferable. In addition, when the surface roughness exceeds 0.15 μm, foreign substances may be accumulated or stuck, which is not preferable.

The foreign substance adhesion prevention coating layer may have a hardness of 1,800 to 2,000.

The foreign substance adhesion prevention coating layer may be formed of one or more coatings selected from a diamond-like carbon (DLC) coating, an AlCrN (Alcrona) coating, and the like, but is not limited thereto, and a known coating material may be used without limitation as long as a coating satisfies a material of the coating layer.

In an embodiment of the present invention, the electrode sheet 10 may include a coated portion that is coated with an electrode active material and a non-coated portion that is not coated with the electrode active material, on one surface or both surfaces of an electrode current collector.

In an embodiment of the present invention, the notching may be a process of notching an electrode tab or cutting the electrode into individual units.

Although the present invention has been described in relation to the above-described embodiments, various modifications and alterations may be made without departing from the gist and scope of the present invention. Accordingly, these modifications and alterations fall within the scope of the claims as long as they belong to the gist of the present specification.

### DESCRIPTION OF REFERENCE NUMERALS

10: electrode sheet
20: transfer part
30: laser irradiation part
32: laser beam
34: laser oscillation part
36: suction part
40: pattern jig
42: pattern hole
44: panel
46: pattern jig fixing groove
48: pattern hole wall
49: coating layer
50: suction device
52: suction hole
54: suction pipe
56: suction device
100: electrode manufacturing device

1. An electrode manufacturing device, comprising:
a transfer part configured to continuously transfer an electrode sheet in order to perform an electrode notching process;
a laser irradiation part configured to irradiate the electrode sheet with a laser beam to perform the electrode notching process; and
a pattern jig positioned to face the laser irradiation part with the electrode sheet interposed therebetween to support the electrode sheet,
wherein the pattern jig includes a panel having a pattern hole through which the laser beam passes, the pattern hole having a width that increases in a direction the laser beam travels.

2. The electrode manufacturing device of claim 1, wherein the pattern hole is formed as a through hole in the panel, and a wall forming the through hole includes an inclined part forming an interior angle of 15° to 80° with an upper surface of the panel directed toward the laser irradiation part.

3. The electrode manufacturing device of claim 1, wherein the pattern hole is formed as a through hole in the panel, and a wall forming the through hole forms an interior angle of 15° to 70° with an upper surface of the panel directed toward the laser irradiation part.

4. The electrode manufacturing device of claim 1, wherein the panel has a thickness of 1.0 mm or less.

5. The electrode manufacturing device of claim 1, wherein the panel is a flat panel or a curved panel convex in a direction toward the electrode sheet.

6. The electrode manufacturing device of claim 1, wherein the pattern jig is fixed to an upper portion of a suction device.

7. The electrode manufacturing device of claim 5, wherein the panel is the curved panel, and the pattern jig comprising the curved panel is fixed to a cylindrical drum suction device.

8. The electrode manufacturing device of claim 7, wherein a plurality of the pattern jigs each comprising one of a plurality of the curved panels are fixed to the cylindrical drum suction device, such that electrode notching can be performed while the plurality of pattern jigs rotate around the cylindrical drum suction device and separately align with the laser irradiation part for electrode notching.

9. The electrode manufacturing device of claim 1, wherein an adhesion prevention coating layer is further disposed on a surface of the panel.

10. The electrode manufacturing device of claim 9, wherein the adhesion prevention coating layer has a friction coefficient of 0.3 or less and a surface roughness of 0.15 μm or less.

11. The electrode manufacturing device of claim 9, wherein the adhesion prevention coating layer is formed of one or more coatings selected from a group of coatings, the group of coatings including diamond-like carbon (DLC) coating and an AlCrN coating.

12. The electrode manufacturing device of claim 1, wherein one or more surfaces of an electrode current collector of the electrode sheet includes a coated portion that is coated with an electrode active material and a non-coated portion that is not coated with the electrode active material.

13. The electrode manufacturing device of claim 1, wherein the electrode manufacturing device is configured to be used in a notching process for forming an electrode tab.

14. The electrode manufacturing device of claim 7, wherein the plurality of the pattern jigs comprises three to ten of the pattern jigs.
